(19) United States
(12) Patent Application Publication
(10) Pub. No.: US 2008/0294310 A1
(43) Pub. Date: Nov. 27, 2008

(54) CONTROL METHOD FOR A MOTORIZED VEHICLE IN THE CASE OF A FAULT THAT ADVISES/IMPOSES DRIVING THE VEHICLE WITH REDUCED PERFORMANCE

(76) Inventors: Daniele Benassi, Bologna (IT); Stefano Sgatti, Imola (IT); Loris Lambertini, Crespellano (IT)

Correspondence Address: OSTROLENK FABER GERB & SOFFEN, 1180 AVENUE OF THE AMERICAS, NEW YORK, NY, 100368403, US

(21) Appl. No.: 12/125,273

(22) Filed: May 22, 2008

(30) Foreign Application Priority Data
May 25, 2007 (EP) 07425323.8

(51) Int. Cl. G06F 17/00

(52) U.S. Cl. 701/29

(57) ABSTRACT

Control method for a vehicle with an engine in the case of a fault that advises/imposes driving the vehicle with reduced performance; the control method provides for the phases of: diagnosing the fault, limiting the maximum performance of the vehicle by degrading the performance of an engine of the vehicle and giving the driver of the vehicle advance warning of the imminent operation of performance degradation on the engine before effectively degrading the performance of the engine.

### TECHNICAL FIELD

The present invention concerns a control method for a motorized vehicle in the case of a fault that advises/imposes driving the vehicle with reduced performance.

The present invention finds useful application in the control of a motor vehicle (or rather, a two-wheeled vehicle), to which the following description will make explicit reference, but without any loss in generality.

### BACKGROUND ART

Electronics, both passive (sensors to detect control quantities) and active (actuators for directly operating mechanical components), are increasingly present in modern motor vehicles. For example, virtually all motor vehicles have electronic injection, or rather fuel injectors that are operated by electric actuators piloted by an electronic control unit, and are fitted with a lambda sensor, or rather a probe able to detect the composition of the exhaust gas. Recently, the application of DBW (Drive By Wire) systems has been proposed, in which the accelerator is no longer mechanically connected to the engine throttle control, but is only connected to a position sensor that detects the position of the accelerator and, in consequence, pilots an actuator that mechanically operates the butterfly valve.

The massive presence of onboard electronics in a motor vehicle allows the detection of fault situations that are not completely prejudicial to driving the motor vehicle, but advise or impose driving the motor vehicle with reduced performance. In other words, in the presence of certain faults diagnosable by the onboard electronics, driving the motor vehicle at maximum performance is dangerous for the safety of the driver and/or the mechanics, whilst driving the motor vehicle with reduced performance is possible (or rather, fairly safe) in order to reach a service centre with the motor vehicle without needing to call a tow truck. When the electronic control unit of a motor vehicle detects the onset of a fault that advises or imposes driving the motor vehicle with reduced performance, the electronic control unit degrades the performance of the motor vehicle, for example, by limiting the maximum number of revs that the engine can reach and/or limiting the maximum speed that the motor vehicle can reach.

For example, in a DBW (Drive By Wire) system, the position of the accelerator is detected by a position sensor fitted with at least two mutually redundant potentiometers; in the case where one of the two potentiometers of the position sensor for the accelerator fails, the position of the accelerator can still be determined by using the other potentiometer, but with a lower level of reliability as comparison with another reading is no longer possible. Therefore, in the case of failure of one of the two potentiometers of the position sensor for the accelerator, the electronic control unit does not completely block the motor vehicle from being driven, but only allows it to be driven with significantly reduced performance to allow a service centre to be reached with the motor vehicle.

Nevertheless, to determine the instant in which a motorcycle's performance should be degraded (i.e. reduce drive torque to the rear wheel) is problematic, because a motorcycle has a dynamic stability that can be upset by a sudden reduction in drive torque to the rear wheel; for example, a reduction in drive torque while riding round a bend, and therefore with the motorcycle inclined with respect to the vertical, can cause the rider to fall.

### DISCLOSURE OF INVENTION

The object of the present invention is to provide a control method for a motorized vehicle in the case of a fault that advises/imposes driving the vehicle with reduced performance, this control method being devoid of the above-described drawbacks and, in particular, being of easy and economic embodiment.

In accordance with the present invention, a control method is provided for a motorized vehicle in the case of a fault that advises/imposes driving the vehicle with reduced performance as claimed in the attached Claims.

### BRIEF DESCRIPTION OF THE DRAWINGS

The present invention shall now be described with reference to the attached drawings, which illustrate a non-limitative example of embodiment, in which:

FIG. 1 is a schematic view of a motorcycle that implements the present invention's control method in the case of a fault, and

FIG. 2 is a schematic view of an internal combustion engine of the motorcycle in FIG. 1.

### PREFERRED EMBODIMENTS OF THE INVENTION

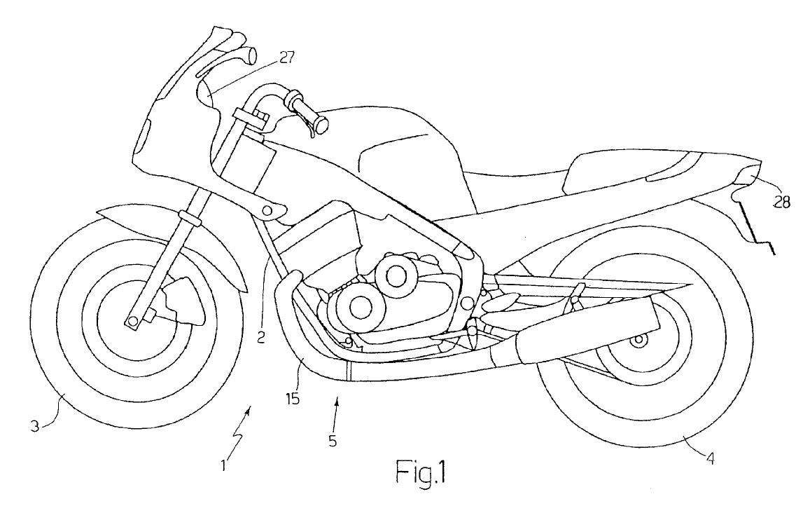

In FIG. 1, reference numeral 1 indicates a motorcycle as a whole, comprising a chassis 2 that supports a front wheel 3 via a front suspension, a rear wheel 4 via a rear suspension and a petrol-fuelled internal combustion engine 5.

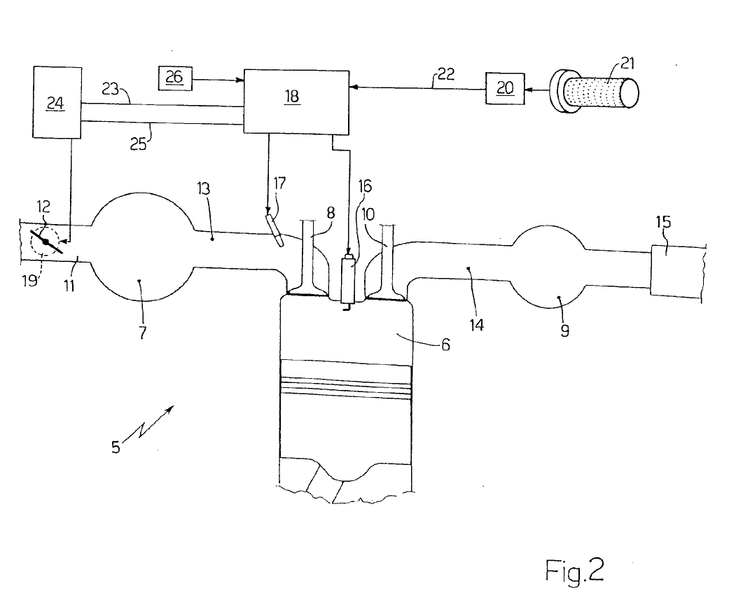

As shown in FIG. 2, the internal combustion engine 5 is fitted with a number of cylinders 6 (only one of which is shown in FIG. 2), each of which is connected to an intake manifold 7 via two intake valves 8 (only one of which is shown in FIG. 2) and an exhaust manifold 9 via two exhaust valves 10 (only one of which is shown in FIG. 2).

The intake manifold 7 receives fresh air (or rather air coming from the outside environment) through a feed duct 11 regulated by a butterfly valve 12 and is connected to the cylinders 6 via respective intake ports 13 (only one of which is shown in FIG. 2), each of which is regulated by the corresponding intake valves 8. Similarly, the exhaust manifold 9 is connected to the cylinders 6 via respective exhaust ports 14 (only one of which is shown in FIG. 2), each of which is regulated by the corresponding exhaust valves 10; an exhaust pipe 15, terminating in a silencer, runs from the exhaust manifold 9 to discharge the gases produced by combustion into the atmosphere.

Each cylinder 6 includes a spark plug 16, which is positioned at the top of the cylinder 6 and is cyclically piloted to ignite the mixture at the end of the compression phase (that is in correspondence to TDC—Top Dead Centre). According to the embodiment shown in FIG. 2, the fuel (or rather the petrol) is injected inside each intake port 13 via a respective injector 17 positioned close to the corresponding intake valves 8. According to another embodiment, not shown, the injectors 16 are positioned in a manner to inject fuel directly into each cylinder 6.

An electronic control unit 18 superintends the running of the internal combustion engine 5, piloting the injectors 17 and the spark plugs 16. In addition, the electronic control unit 18 implements a DBW (Drive By Wire) system; in consequence, the butterfly valve 12 is servo-controlled and is operated by an electric actuator 19 that is controlled by the electronic control unit 18 according to the signals received from a position sensor 20, which detects the position of an accelerator 21 of the motorcycle 1 in real time. For safety reasons, the position sensor 20 has at least two mutually redundant potentiometers, so that the reading provided by a potentiometer can always be confirmed by the reading provided by the other potentiometer.

According to the embodiment shown in FIG. 2, the electronic control unit 18 is connected by an electric cable 22 to the position sensor 20 and is connected by a CAN/BUS type electric cable 23 to an electric drive 24 that pilots the electric actuator 19; in other words, the electronic control unit 18 sends the desired position for the butterfly valve 12 to the electric drive 24 via the AN/BUS type electric cable 23 and the electric drive 24 supplies the necessary electric current (via a feedback control) to the electric actuator 19 to set the butterfly valve 12 in the desired position. According to the embodiment shown in FIG. 2, the electronic control unit 18 is connected to the electric drive 24 via an additional electric cable 25 that controls the switching on and off of the electric drive 24. The electronic control unit 18 is also connected to a speed sensor 26, which determines the speed (or rather the number of revolutions) of the internal combustion engine 5.

The electronic control unit 18 includes a plurality of diagnostic algorithms that are cyclically executed to determine the onset of possible faults in components of the motorcycle 1. Some faults do not involve the main components of the motorcycle 1 and are therefore just signalled to the rider of the motorcycle 1 by the turning on of a specially provided warning light on an instrument panel 27. Instead, other faults involve the main components of the motorcycle 1 and render driving at maximum performance dangerous for the rider and/or mechanics, whilst driving the motorcycle 1 with reduced performance is possible (or rather, fairly safe) in order to reach a service centre with the motorcycle 1.

A typical example of a fault that requires driving the motorcycle 1 with reduced performance is the failure of one of the two potentiometers of the position sensor 20; in this case, it is possible to read the angular position of the accelerator 21 using a single potentiometer, but this reading is less reliable as it cannot be compared with another (redundant) reading and it would therefore not be adequately safe to allow the rider to use the motorcycle 1 with maximum performance.

When the electronic control unit 18 determines the onset of a fault that advises/imposes driving the motorcycle 1 with reduced performance, the electronic control unit 18 limits the maximum performance of the motorcycle 1 by degrading the performance of the internal combustion engine 5 of the motorcycle 1 (for example, by limiting the maximum number of revs that the internal combustion engine 5 can reach and/or limiting the maximum speed that the motorcycle 1 can reach). In other words, the electronic control unit 18 disposes of a series of emergency or recovery strategies that are automatically activated when a fault arises and the purpose of which is to allow the rider of the motorcycle 1 to reach a service centre with an acceptable level of safety.

The motorcycle 1 has dynamic stability that can be upset by a sudden reduction in drive torque to the rear wheel 4; for example, a reduction in drive torque while riding round a bend, and therefore with the motorcycle 1 inclined with respect to the vertical, can cause the rider to fall. For this reason, the electronic control unit 18 warns the rider of the motorcycle 1 in advance and in a fitting manner of the imminent operation of performance degradation on the internal combustion engine 5 before performance of the internal combustion engine 5 is effectively degraded.

To warn the rider in advance, the electronic control unit 18 turns on a specially provided warning light on the instrument panel 27 and simultaneously performs at least one sequence (generally a series of time-staggered sequences) of impulsive reductions in the drive torque generated by the internal combustion engine 5. In other words, a sequence or train of impulsive reductions in the drive torque generated by the internal combustion engine 5 is repeated several times with a certain time lapse between two successive sequences. In this way, the rider notices obvious uneven running (i.e. partially jerky running) of the motorcycle 1, but without a substantial reduction occurring in the drive torque applied to the rear wheel 4; in other words, the sequence of impulsive reductions in drive torque do not cause a substantial reduction in the drive torque applied to the rear wheel 4, but simply cause partially jerky running. When the rider notices obvious uneven running (i.e. partially jerky running) of the motorcycle 1, the rider is directly warned that there is a problem in an unequivocal way and in a manner that cannot be ignored; in consequence, the rider will naturally reduce speed and will carefully check the instrument panel 27 to try to establish the type of problem.

Preferably, each impulsive reduction in the drive torque generated by the internal combustion engine 5 is produced by misfiring of the mixture inside at least one cylinder 6 of the internal combustion engine 5; misfiring of the mixture inside a cylinder 6 is achieved by temporarily blocking the injection of fuel (i.e. avoiding to pilot the respective injector 17) and/or temporarily blocking ignition spark generation by the respective spark plug 16.

Furthermore, in addition to warning the rider in advance, the electronic control unit 18 turns on a brake light 28 of the motorcycle 1 for a certain time interval before effectively degrading the performance of the internal combustion engine 5 and/or turns on the brake light 28 of the motorcycle 1 for a certain time interval when the performance of the internal combustion engine 5 is effectively degraded. The turning on of the brake light 28 can be intermittent or continuous.

The above-described control method for the motorcycle 1 in the case of a fault that advises/imposes driving the motorcycle 1 with reduced performance offers numerous advantages, as it is simple and economic to produce and, above all, provides a high level of safety, both for the rider of the motorcycle 1 and for any vehicles that follow the motorcycle 1.

In fact, when the rider notices uneven running on the motorcycle 1 caused by the series of sequences of impulsive reductions in the drive torque generated by the internal combustion engine 5, the rider will naturally reduce speed and carefully check the instrument panel 27 to try to establish the type of problem. In consequence, when the electronic control unit 18 effectively degrades the performance of the internal combustion engine 5, the rider will be in a state of alertness and will be driving the motorcycle 1 at a moderate speed (i.e. the rider will be ready to keep the motorcycle 1 under control). In this way, possible damage to the motorcycle 1 and/or injury the rider through application of a safety strategy that is automatically activated following identification of a fault is avoided.

It is important to note that just turning on an indicator light on the instrument panel 27 and/or a horn, which might be sufficient in a car, are not sufficient on a motorcycle, where the rider does not have adequate peripheral vision of the instrument panel 27 (also due to the presence of the crash helmet) and often does not hear the noise produced by a horn (due to the effect of the noise of the internal combustion engine 5, aerodynamic noise and use of the crash helmet).

Furthermore, thanks to the automatic turning on of the brake light 28 of the motorcycle 1, any vehicle following the motorcycle 1 is also warned that the motorcycle 1 is slowing down or about to slow down and therefore the risk of collision with the motorcycle 1 is also reduced.

The above-described control method for the motorcycle 1 in the case of a fault that advises/imposes driving the motorcycle 1 with reduced performance finds useful application in two-wheeled vehicles, which have critical stability, but can also find application on any other type of vehicle with four or more wheels, such as a car or truck.

1. Control method for a vehicle (1) with an engine (5) in the case of a fault that advises/imposes driving the vehicle (1) with reduced performance; the control method comprises the phases of:
diagnosing the fault, and
limiting the maximum performance of the vehicle (1) by degrading the performance of an engine (5) of the vehicle (1);
the control method is characterized in comprising the additional phase of:
giving the driver of the vehicle (1) advance warning of the imminent operation of performance degradation on the engine (5) before effectively degrading the performance of the engine (5).

2. Control method according to claim 1, wherein the phase of giving the driver advance warning contemplates carrying out at least one sequence of impulsive reductions in the drive torque generated by the engine (5).

3. Control method according to claim 2, wherein the phase of giving the driver advance warning contemplates carrying out a series of sequences of impulsive reductions in the drive torque generated by the engine (5).

4. Control method according to claim 3, wherein the sequence of impulsive reductions in the drive torque generated by the engine (5) is repeated several times with a certain time lapse between two successive sequences.

5. Control method according to claim 2, wherein each impulsive reduction of the drive torque generated by the engine (5) is produced via the misfiring of the mixture inside at least one cylinder (6) of the engine (5).

6. Control method according to claim 5, wherein misfiring of the mixture inside a cylinder (6) is achieved by temporarily blocking the injection of fuel.

7. Control method according to claim 5, wherein misfiring of the mixture inside a cylinder (6) is achieved by temporarily blocking the generation of an ignition spark by a spark plug (16) of the cylinder (6).

8. Control method according to claim 1 and comprising the additional phase of turning on a brake light (28) of the vehicle (1) for a certain time interval and before effectively degrading the performance of the engine (5).

9. Control method according to claim 1 and comprising the additional phase of turning on a brake light (28) of the vehicle (1) for a certain time interval when the performance of the engine (5) is effectively degraded.

10. Control method according to claim 8, wherein the brake light (28) of the vehicle (1) is switched on intermittently.

11. Control method according to claim 8, wherein the brake light (28) of the vehicle (1) is switched on continuously.
